(19) United States
(12) Patent Application Publication
(10) Pub. No.: US 2015/0267469 A1
(43) Pub. Date: Sep. 24, 2015

(54) Ladder Plank

(71) Applicant: Joe Markusen, Brownstown, MI (US)

(72) Inventor: Joe Markusen, Brownstown, MI (US)

(21) Appl. No.: 14/221,729

(22) Filed: Mar. 21, 2014

(51) Int. Cl. E06C 1/16; E06C 1/39; E06C 7/42

(52) U.S. Cl. CPC E06C 1/16; E06C 7/42; E06C 1/39

(57) ABSTRACT

The present invention is a multi-purpose ladder. It is a fully functional approximately 6 feet step ladder which most people have, and it also serves as a 6 feet platform when laid horizontally that will extend approximately 12-18 inches off the floor. The invention is useful when a person needs to reach higher than they can reach with both feet on the ground such as working on the ceiling or the top of the wall (painting) or doing trim and crown molding. It is also useful when moving a ladder every couple of feet gets tedious and time consuming. The ladder plank of the present invention allows people to cover more space with less moving of the ladder.

### BACKGROUND OF THE INVENTION

1. Field of the Invention

This invention relates to a multi-purpose ladder and more particularly to a ladder which can function as a step ladder as well as a platform.

2. Description of Related Art

People use ladders for elevation, when reaching objects or working on levels that are far higher than people can reach from floor or ground. When people paint on the ceiling or the top of walls, or do trimming and crown molding, they need to climb up the ladder, work on the space that they can reach, get off the ladder, move the ladder a couple of feet, climb up the ladder, work on the space that they can reach, and get off the ladder, move the ladder and repeat the same process until the job is done. This process is tedious and time consuming and can be dangerous due to frequent climbing up and down. Therefore, it is desirable to have an invention that can be easily converted between a ladder and a platform so that people can use as a ladder as well as a platform to reach more space at a time and thus saving time, improving efficiency and safety.

### SUMMARY OF THE INVENTION

The present invention is a multi-purpose ladder. It is a fully functional approximately 6 feet step ladder which most people have, and it also serves as a 6 feet platform that will extend approximately 12-18 inches off the floor.

The invention is useful when a person needs to reach higher than they can reach with both feet on the ground such as working on the ceiling or the top of the wall (painting) or doing trim and crown molding. It is also useful when moving a ladder every couple of feet gets tedious and time consuming. The ladder plank of the present invention allows people to cover more space with less moving of the ladder.

In an exemplary embodiment of the present invention, there is disclosed a ladder plank comprising a ladder, a plank which is pivotally coupled to the ladder at the top, and a plurality of foldable legs that are pivotally attached to the ladder. The ladder comprises two rails and a plurality of steps jointing the two rails. The ladder and plank are pivotally coupled at the top and connected by spreaders in the middle, allowing the ladder and plank to pivot away from and towards one another between folded and unfolded configurations.

When the ladder plank is in an unfolded configuration, the plank and the ladder form an A-shape and work together like a step ladder that most people have. When the ladder plank is in a folded configuration, the ladder plank can be laid horizontally on the floor with the plank on top of the ladder and work together like a platform. The foldable legs attached to the ladder can be unfolded to add additional height to the platform, allowing people to reach the ceiling and the top of the walls when standing on the platform.

In one embodiment of the present invention, the folded configuration of the ladder plank serves as an approximately 6 feet platform that extends approximately 12-18 inches off the floor.

The length of the foldable legs may be different in another embodiment, and thus the platform will extend to a different height off the floor. In another embodiment, the length of the foldable legs may be adjustable.

In the preferred embodiment, the ladder plank comprises four foldable legs of the same length to the rails of the ladder via rivets; two legs are attached to the rails of the ladder near the top end and two are attached to the rails of the ladder near the lower end. In another embodiment, the ladder plank may comprise more foldable legs.

The ladder plank may further comprise a shelf or a bar near the top of the ladder to provide a small workspace for the individual working on the ladder. This shelf or bar may hold a paint can or various tools.

Another embodiment of the ladder plank comprises a feature that allows for a bar to unfold while the ladder is in the plank position with a hook attached thereon for hanging a paint can or a tool bag.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view showing a man standing on the ladder plank of the present invention wherein the ladder plank is in a folded configuration and is laid horizontally to serve as a platform.

FIG. 2 is a perspective view showing a man standing on the ladder plank of the present invention wherein the ladder plank is in an unfolded configuration and is erected to function as a step ladder.

FIG. 3 is a perspective view of the ladder plank of the present invention which is in an unfolded configuration and functions like a step ladder.

FIG. 4 is a close-up partial view of the ladder plank of the present invention showing that the foldable leg pivots away from the rail of the ladder from a folded configuration to a half-opened configuration and to an unfolded configuration.

FIG. 5 is a perspective view of the ladder plank of the present invention which is in a folded configuration serving as a platform which is further supported by the unfolded legs.

FIG. 6 is a perspective view of the ladder plank which further comprises a shelf for holding a paint can or various tools.

### DESCRIPTION OF THE PREFERRED EMBODIMENT

All illustrations of the drawings are for the purpose of describing selected versions of the present invention and are not intended to limit the scope of the present invention.

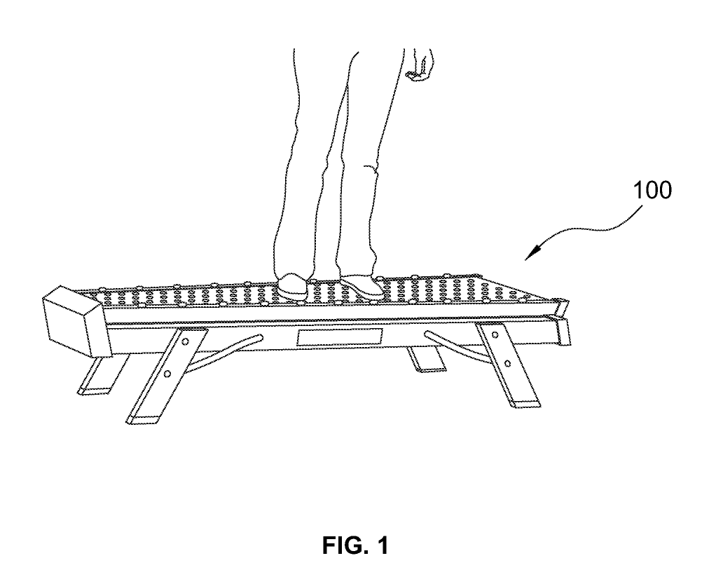

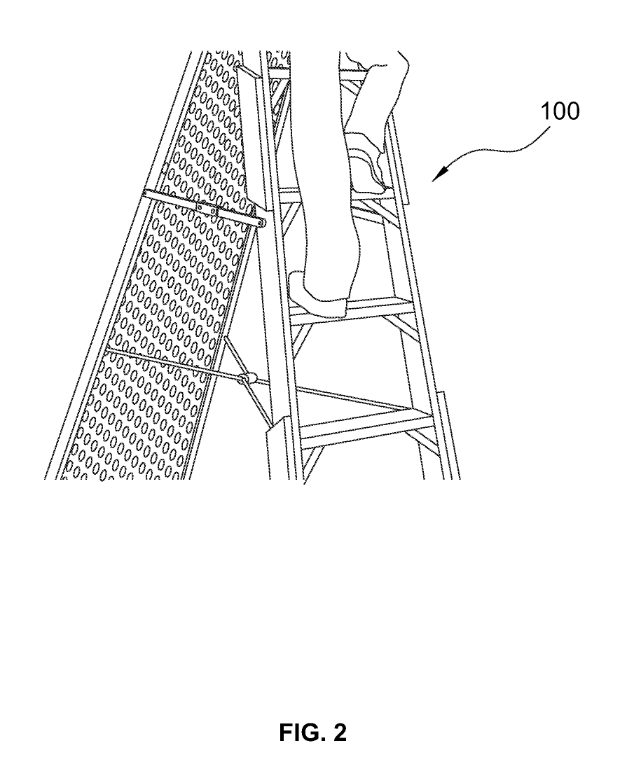

Referring to FIGS. 1 and 2 there is disclosed a ladder plank according to the present invention. FIG. 1 shows a man standing on the ladder plank of the present invention wherein the ladder plank is in a folded configuration and is laid horizontally to serve as a platform. FIG. 2 shows a man standing on the ladder plank of the present invention wherein the ladder plank is in an unfolded (opened) configuration and is erected to function as a step ladder.

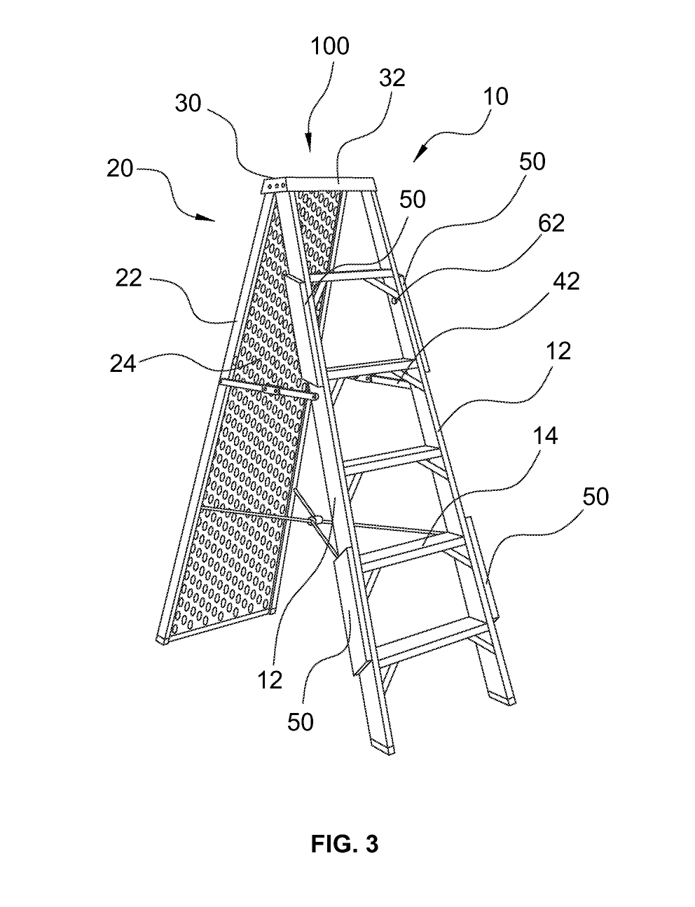

Referring to FIG. 3, the ladder plank 100 of the present invention comprises a ladder section 10 and a plank section 20. The ladder 10 comprises two rails 12, and a plurality of parallel steps 14 jointing the two rails. The steps closer to the bottom of the ladder are the widest. The steps closer to the top of the ladder are the narrowest. The steps may have treads to ensure traction. The bottom of each rail is covered by a black rubber cap 16 to increase resistance and prevent the ladder from sliding on the ground. The plank 20 comprises two plank rails 22 and one large piece of material 24 between the two rails. The large piece of material is made of tough material which may be metal, glass fiber, or tough plastic. In the preferred embodiment, the large piece of material 24 is a piece of anodized aluminum. The ladder 10 and plank 20 are coupled by bridging members 30 at the top and by spreaders 40 in the middle.

The bridging members 30 pivotally mounted at the top of the ladder plank allow the plank and ladder to pivot away from one another to form an A shape unfolded configuration or pivot towards one another to a folded configuration.

The rail spreaders 42 are the metal bars that feature hinges which connect the rails 12, 22 of the ladder and plank. These spreaders 42 are one-way hinged in the middle, allowing the ladder 10 and plank 20 to pivot away from or towards one another between unfolded and folded configurations. The hinges on the spreaders are lockable, which provides stability when the ladder is in use.

When the ladder and plank pivot away from one another at the bottom forming an angle, the plank 20 supports the ladder 10 to function as a step ladder in this unfolded configuration as shown in FIGS. 2 and 3. In one embodiment, the bridging members 30 has an ABS plastic cover 32 to prevent a user from slipping off the ladder when standing on the steps of the ladder.

The ladder plank 100 of the present invention further comprises foldable legs 50 hinged to the rails 12 of the ladder via rivets 62. In the preferred embodiment as shown in FIG. 3, the ladder plank comprises four foldable legs 50 of the same length which are attached to the rails of the ladder via rivets 62; two legs 50 are located near the top end and the other two 50 are located near the lower end.

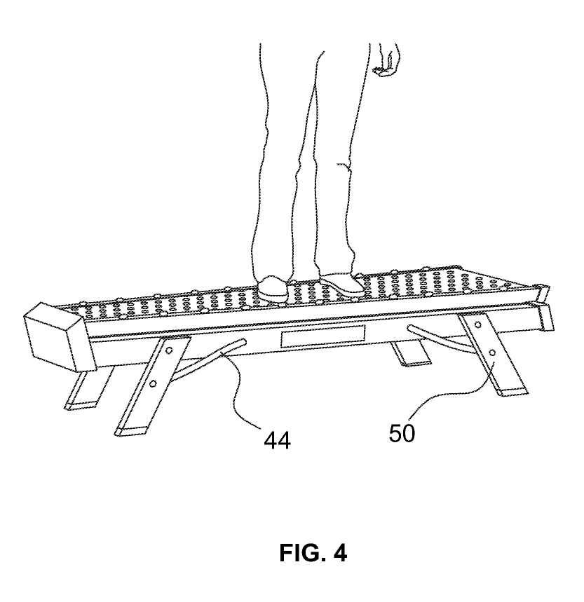

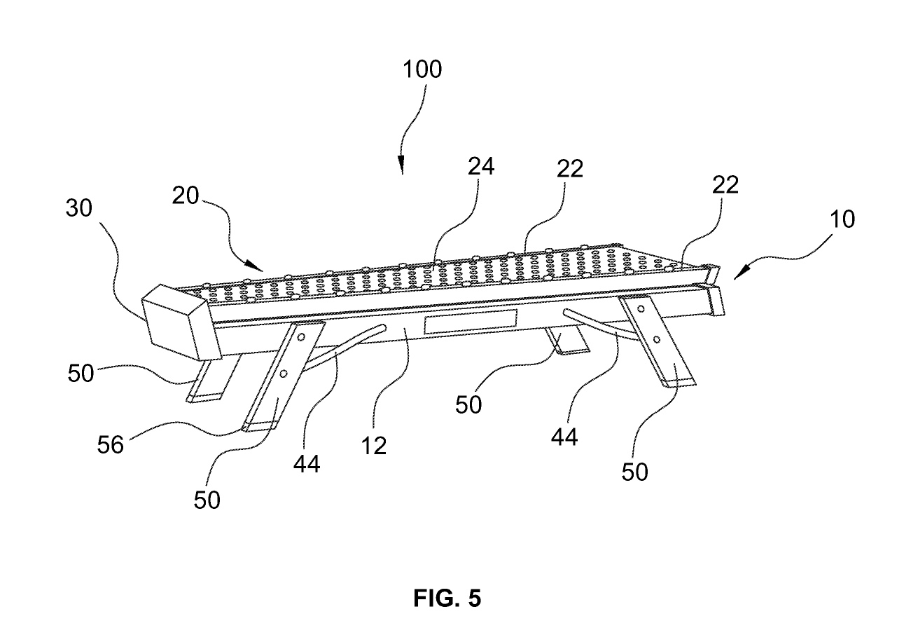

Additionally, each of the foldable legs 50 is connected in the middle to the rail by a leg spreader 44 which is one-way hinged in the middle, allowing the leg 50 and the ladder 10 to pivot away from or towards one another between the folded (as shown in FIG. 3) and unfolded configurations (as shown in FIG. 5). The leg spreaders 44 provide additional stability when the legs 50 are unfolded for use. FIG. 4 shows a close-up view of the foldable leg 50 and leg spreader 44 attached to the rail 12 of the ladder. Said leg can position from the folded configuration to the half-open and to the unfolded configuration.

When the ladder plank 100 is used as a step ladder in an unfolded configuration, the foldable legs 50 are folded so they are out of the way.

Referring to FIG. 5, the ladder 10 and plank 20 when moved close to one another (at bottom) and are laid horizontally on the floor, the ladder plank 100 is in a folded configuration and serves as a platform to support an individual working on the ceiling or the top of the wall (painting) or doing trim and crown molding. The foldable legs 50 are now unfolded to add additional height that the individual needs to reach the ceiling and the top of the wall as shown in FIG. 1. The bottom of the legs 50 is covered by a rubber leg cap 56 to increase resistance and prevent the platform from sliding on the ground.

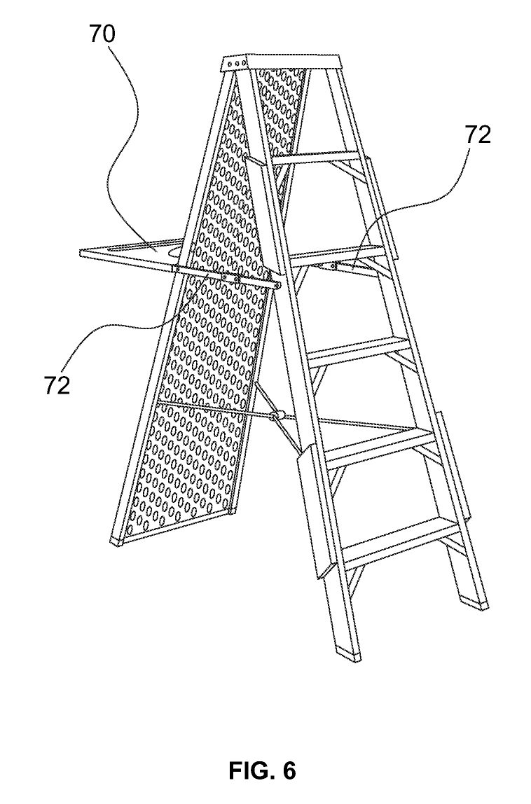

Referring to FIG. 6, the ladder plank 100 may further comprise a shelf 70 or a bar attached to the rails of the ladder to provide a small workspace for the individual working with the ladder. This shelf or bar may hold a paint can or various tools. The shelf 70 may be connected to the ladder—in the location seen herein or higher up along the ladder side—by shelf spreaders 72 which are one-way hinged in the middle, allowing the shelf 70 and ladder 10 to pivot away from one another so it can be opened for the desired purpose and closed when it is not needed. The shelf or bar locks into place to maximize stability.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A ladder plank comprising:
a ladder comprising a pair of rails and a plurality of parallel steps jointing the two rails of the ladder;
a plank comprising a pair of rails and a large piece of material jointing the two rails of the plank;
a bridging member pivotally mounted on a top of the ladder and the plank;
rail spreaders attached to the middle of the rails of the ladder and the plank; the bridging member and rail spreaders allowing the ladder and plank to pivot away from and towards one another between folded and unfolded configurations;
foldable legs pivotally attached to the two rails of the ladder; and
leg spreaders each of which being hinged in the middle having one end attached to the middle of the foldable leg and another end attached to the rail of the ladder, allowing the leg and rail to pivot away from and towards one another between folded and unfolded configurations, and ensuring stability when the leg is unfolded for use;
wherein when the ladder plank is in the unfolded configuration and the foldable legs are in the folded configuration the ladder plank functions as a step ladder, and when the ladder plank is in the folded configuration and the foldable legs are in the unfolded configuration the ladder plank serves as a platform.

2. The ladder plank of claim 1, further comprise a shelf connected to the ladder for holding paint can and tools.

3. The ladder plank of claim 2, wherein the ladder plank is approximately 6 feet long and serves as a 6 feet platform that extends approximately 12-18 inches off the floor.

4. The ladder plank of claim 3, wherein the ladder plank comprises four foldable legs of the same length pivotally attached to the rails of the ladder via rivets, two of which located near the top end of the rails and another two located near a bottom end of the rails.

5. The ladder plank of claim 4, wherein the foldable legs' length are adjustable.

6. The ladder plank of claim 4, wherein the ladder plank comprises more foldable legs.

7. The ladder plank of claim 4, wherein the piece of material is made of firm material including one of metal, fiberglass, tough plastic.

8. The ladder plank of claim 7, wherein the piece of material is made of anodized aluminum.

9. The ladder plank of claim 7, wherein the bottom end of the rails and legs are covered by a rubber cap to increase resistance and prevent the ladder plank from sliding on the ground.

10. The ladder plank of claim 9, wherein the rails are made from lightweight fiberglass.

11. The ladder plank of claim 10, wherein the steps are made from anodized slip resistant aluminum.
